(19) United States
(12) Patent Application Publication
(10) Pub. No.: US 2025/0357786 A1
(43) Pub. Date: Nov. 20, 2025

(54) METHOD FOR DETERMINATION OF PHASE LABELS IN A THREE PHASE ELECTRIC POWER DISTRIBUTION NETWORK

(71) Applicant: Kansas State University Research Foundation, Manhattan, KS (US)

(72) Inventors: Shweta Dahale, Manhattan, KS (US); Bala Natarajan, Manhattan, KS (US)

(21) Appl. No.: 18/870,933

(22) PCT Filed: Jun. 1, 2023
(86) PCT No.: PCT/US2023/067757

§ 371 Date: Dec. 2, 2024

Related U.S. Application Data
(60) Provisional application No. 63/347,643, filed on Jun. 1, 2022.

(51) Int. Cl. H02J 13/00

(52) U.S. Cl. CPC H02J 13/00002; H02J 13/00001

(57) ABSTRACT

A method for determining a plurality of phase labels, each phase label identifying a phase of a voltage at one of a lateral or a customer in a three phase power distribution network, comprises receiving data indicating a plurality of electrical connections of the three phase power distribution network; receiving a plurality of sensor data values, each sensor data value being a measured electrical characteristic from at least a portion of the customers; receiving a plurality of known phase labels associated with a portion of the laterals and customers; generating a form of an adjacency matrix associated with a graph of the electrical connections of the three phase power distribution network; determining the values of the adjacency matrix which minimize a mathematical function of the sensor data values and the known phase labels; and deriving the phase label for each lateral and customer from the adjacency matrix.

### RELATED APPLICATION

The present application claims priority of U.S. Provisional Patent Application Ser. No. 63/347,643, filed on Jun. 1, 2022, and entitled “METHOD FOR DETERMINATION OF PHASE LABELS IN A THREE PHASE ELECTRIC POWER DISTRIBUTION NETWORK”, which is hereby incorporated in its entirety by reference herein.

### STATEMENT REGARDING FEDERALLY-SPONSORED RESEARCH OR DEVELOPMENT

This invention was made with Government support under Contract No.: DE-EE0008767 awarded by the United States Department of Energy, Office of Energy Efficiency and Renewable Energy (EERE), Solar Energy Technologies Office. The Government has certain rights in the invention.

### FIELD OF THE INVENTION

Embodiments of the current invention relate to methods for determining a phase label of the electric voltage at a plurality of nodes in a three phase electric power distribution network.

### BACKGROUND

Alternating current (AC) electric voltage is generated to have a periodic waveform. Three phase electric voltage provides three AC electric voltage waveforms, with each waveform having a phase that is 120 degrees out of phase with the other two waveforms—thus providing three different voltage phases which are generally labeled “A”, “B”, and “C”. Referring to FIG. 1, electric power distribution networks often utilize the three phase electric voltage configuration when delivering electric power from a network distribution point, such as a substation, to a plurality of customers, such as residential houses, office buildings, stores, schools, and the like. The substation provides three phase voltage to a plurality of feeders, which in turn, provide three phase, two phase, or single phase voltage to a plurality of laterals, which provide single phase voltage (A, B, or C) to the customers. The feeders and laterals may include components like transformers, switches, and so forth which help adjust the power delivered to the customers. The network may also include distributed energy resources, such as rooftop solar cells, local wind turbines, and the like, which increase the complexity of the network.

Knowing the phase of the voltage at each of the lateral and customer points can allow a utility company to balance the customers among the three phases as well as accurately determine the capacity of the network to provide sufficient power. However, over time, knowledge of the specific phase at each of the lateral and customer points is lost due to restoration, reconfiguration, maintenance, addition of customer loads and distributed energy resources, and other changes which are not recorded-leaving the utility company with reduced or limited knowledge to properly operate the network.

### SUMMARY OF THE INVENTION

Embodiments of the current invention address one or more of the above-mentioned problems and provide methods, computing devices, and computer-readable media for determining a phase of the electric voltage at a lateral or customer point in a three phase electric power distribution network. Specifically, embodiments of the current invention may determine phase labels by determining the values of an adjacency matrix which is associated with a graph of the electrical connections of the network.

One embodiment of the current invention provides a computer-implemented method for determining a plurality of phase labels, each phase label identifying a phase of a voltage at one of a lateral or a customer in a three phase power distribution network formed by a plurality of nodes electrically connected to one another and including a plurality of laterals and a plurality of customers. The method broadly comprises receiving data indicating a plurality of electrical connections of the three phase power distribution network; receiving a plurality of sensor data values, each sensor data value being a measured electrical characteristic from at least a portion of the customers; receiving a plurality of known phase labels associated with a portion of the laterals and customers; generating a form of an adjacency matrix associated with a graph of the electrical connections of the three phase power distribution network; determining the values of the adjacency matrix which minimize a mathematical function of the sensor data values and the known phase labels; and deriving the phase label for each lateral and customer from the adjacency matrix.

Another embodiment of the current invention provides a computing device for determining a plurality of phase labels, each phase label identifying a phase of a voltage at one of a lateral or a customer in a three phase power distribution network formed by a plurality of nodes electrically connected to one another and including a plurality of laterals and a plurality of customers. The computing device broadly comprises a processing element in electronic communication with a memory element. The processing element is configured or programmed to: receive data indicating a plurality of electrical connections of the three phase power distribution network; receive a plurality of sensor data values, each sensor data value being a measured electrical characteristic from at least a portion of the customers; receive a plurality of known phase labels associated with a portion of the laterals and customers; generate a form of an adjacency matrix associated with a graph of the electrical connections of the three phase power distribution network; determine the values of the adjacency matrix which minimize a mathematical function of the sensor data values and the known phase labels; and derive the phase label for each lateral and customer from the adjacency matrix.

Yet another embodiment of the current invention provides a non-transitory computer readable medium having stored thereon software instructions for determining a plurality of phase labels, each phase label identifying a phase of a voltage at one of a lateral or a customer in a three phase power distribution network formed by a plurality of nodes electrically connected to one another and including a plurality of laterals and a plurality of customers that, when executed by a processing element, cause the processing element to: receive data indicating a plurality of electrical connections of the three phase power distribution network; receive a plurality of sensor data values, each sensor data value being a measured electrical characteristic from at least a portion of the customers; receive a plurality of known phase labels associated with a portion of the laterals and customers; generate a form of an adjacency matrix associated with a graph of the electrical connections of the three phase power distribution network; determine the values of the adjacency matrix which minimize a mathematical function of the sensor data values and the known phase labels; and derive the phase label for each lateral and customer from the adjacency matrix.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a three phase power distribution network which includes at least one substation, a plurality of feeders, a plurality of laterals, and a plurality of customers;

FIG. 2 is a view of a plurality of components of a computing device constructed in accordance with various embodiments of the invention;

FIG. 3 is a schematic block diagram of the electronic components of the computing device;

FIG. 4 is a listing of a blank adjacency matrix associated with a graph of the electrical connections of the three phase power distribution network;

FIG. 5 is a listing of a voltage matrix formed from a plurality of sensor data values;

FIG. 6 is a listing of an adjacency matrix including values determined from a mathematical function of the sensor data values and a plurality of known phase labels;

FIG. 7 is a schematic block diagram of the three phase power distribution network of FIG. 1 including phase labels for each lateral and customer;

FIG. 8 is a listing of at least a portion of the steps of a method for determining a plurality of phase labels; and

FIG. 9 is a listing of at least a portion of the steps of a method for estimating a state of the three phase power distribution network.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In the following description, the word “voltage” may be used to describe electric voltage, the word “current” may be used to describe electric current, and the word “power” may be used to describe electric power.

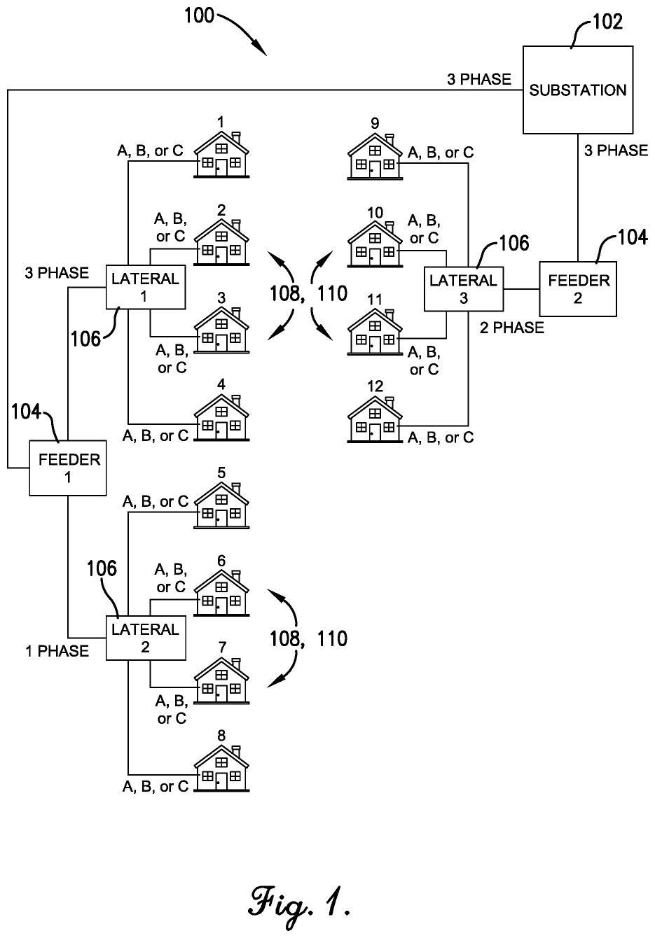

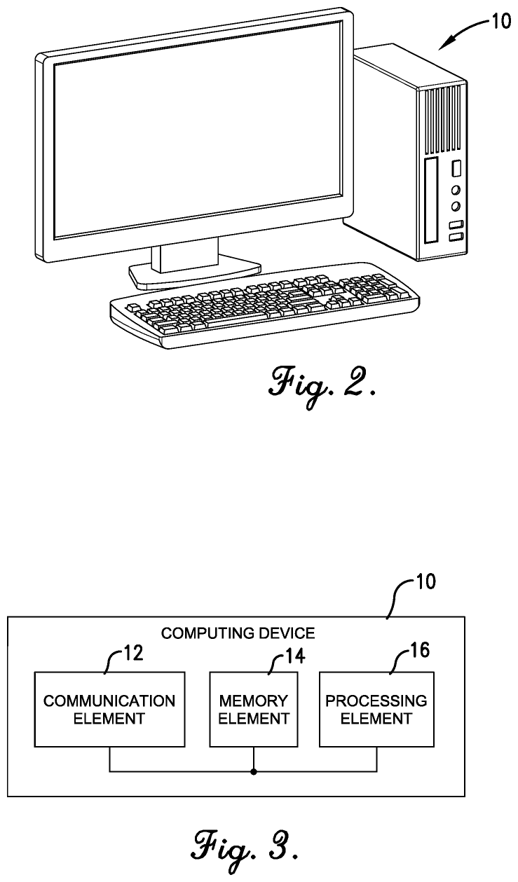

Referring to FIG. 2, a computing device 10, constructed in accordance with various embodiments of the current invention, for determining a phase, or a phase label, of the voltage at a lateral or customer point in a three phase power distribution network 100. The three phase power distribution network 100, as shown in FIG. 1, may cover a portion of a city, a city, a region, or so forth. The three phase power distribution network 100 is formed by a plurality of nodes electrically connected to one another and may include at least one substation 102, a plurality of feeders 104, a plurality of laterals 106, and a plurality of customers 108, among others, wherein each of these components is one of the nodes. The substation 102 may include components such as transformers, switches, circuit breakers, relays, and the like. Each feeder 104 and each lateral 106 may include one or more transformers, switches, and the like. The customers 108 consume power and may include residential houses, office buildings, stores, schools, and the like. (Some customers may also have distributed energy resources, which source electric power.) The substation 102 provides three phase voltage to the feeders 104, which in turn, provide three phase, two phase, or single phase voltage to the laterals 106, which provide single phase voltage to the customers 108. (In some instances, one or more customers 108 may receive three phase voltage.) The three phase power distribution network 100 may further include a plurality of buses, each of which connects one feeder 104 to a plurality of laterals 106 or one lateral 106 to a plurality of customers 108. The exemplary three phase power distribution network 100 includes one substation 102, two feeders 104, a first lateral 106 that receives three phases of voltage, a second lateral 106 that receives one phase of voltage, and a third lateral 106 that receives two phases of voltage. The computing device 10 determines the node phase label, A, B, or C, at each lateral 106 and customer 108.

At least a portion of the customers 108 and the electric power distribution components, such as the substation 102, the feeders 104, and the laterals 106, has a sensor 110, such as a scalar sensor, which measures or determines, at the least, a magnitude of the voltage at each site. In some embodiments, the sensor 110 may also include a phasor measurement unit (PMU) which measures or determines the magnitude and an angle of the voltage at the site. In other embodiments, the sensor 110 may also measure or determine real and/or reactive power consumed by the customer 108. In addition, the sensor 110 includes, or is in communication with, circuitry or components configured to communicate or transmit any measured or determined data including the voltage magnitude, along with the voltage angle, and the real and/or reactive power as a sensor data value to the computing device 10. The sensor data value may be communicated or transmitted wirelessly or using wired networks. For example, the sensor data value may be communicated or transmitted via the Internet, cloud networks, telecommunication networks, or the like. The sensor data values are transmitted on a periodic basis. For example, the sensor data values may be transmitted several times per day, such as once every one or two hours, although a higher or a lower frequency may be implemented as well. Furthermore, in some embodiments, each sensor data value may be accompanied by an identification code or number, a location, such as an address or a geolocation, or both.

An exemplary sensor 110 may be embodied by a supervisory control and data acquisition (SCADA) sensor which is configured or operable to provide one sensor data value at a rate ranging from 1 per second to 1 per minute. A micro PMU sensor 110 may provide 512 sensor data values for a 60 hertz (Hz) frequency for a total output of 30,720 sensor data values per second. The sensor 110 may be configured, however, to transmit a plurality of sensor data values during a single transmission that is transmitted once every 1-2 hours.

The computing device 10, as shown in FIG. 2, may be embodied by one or more servers, high performance computers, workstation computers, desktop computers, laptop computers, palmtop computers, notebook computers, tablets or tablet computers, and so forth. The computing device 10, as shown in FIG. 3, includes a communication element 12, a memory element 14, and a processing element 16. The computing device 10 may also include a display or monitor, a keyboard, a mouse, and other components not discussed herein.

The communication element 12 generally allows the computing device 10 to communicate with other computing devices, external systems, networks, and the like. The communication element 12 may include signal and/or data transmitting and receiving circuits, such as antennas, amplifiers, filters, mixers, oscillators, digital signal processors (DSPs), and the like. The communication element 12 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 12 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 12 may establish communication through connectors or couplers that receive metal conductor wires or cables which are compatible with networking technologies such as ethernet. In certain embodiments, the communication element 12 may also couple with optical fiber cables. The communication element 12 may be in electronic communication with the memory element 14 and the processing element 16.

The memory element 14 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 14 may be embedded in, or packaged in the same package as, the processing element 16. The memory element 14 may include, or may constitute, a non-transitory “computer-readable medium”. The memory element 14 may store the instructions, code, code statements, code segments, software, firmware, programs, applications, apps, services, daemons, or the like that are executed by the processing element 16. The memory element 14 may also store data that is received by the processing element 16 or the device in which the processing element 16 is implemented. The processing element 16 may further store data or intermediate results generated during processing, calculations, and/or computations as well as data or final results after processing, calculations, and/or computations. In addition, the memory element 14 may store settings, text data, documents from word processing software, spreadsheet software and other software applications, sampled audio sound files, photograph or other image data, movie data, databases, and the like.

The processing element 16 may comprise one or more processors. The processing element 16 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 16 may generally execute, process, or run instructions, code, code segments, code statements, software, firmware, programs, applications, apps, processes, services, daemons, or the like. The processing element 16 may also include hardware components such as registers, finite-state machines, sequential and combinational logic, configurable logic blocks, and other electronic circuits that can perform the functions necessary for the operation of the current invention. In certain embodiments, the processing element 16 may include multiple computational components and functional blocks that are packaged separately but function as a single unit. In some embodiments, the processing element 16 may further include multiprocessor architectures, parallel processor architectures, processor clusters, and the like, which provide high performance computing. The processing element 16 may be in electronic communication with the other electronic components of the computing device 10 through serial or parallel links that include universal busses, address busses, data busses, control lines, and the like. In addition, the processing element 16 may include ADCs to convert analog electronic signals to (streams of) digital data values and/or digital to analog converters (DACs) to convert (streams of) digital data values to analog electronic signals.

The processing element 16 may be operable, configured, or programmed to perform the following functions, processes, methods, or algorithms by utilizing hardware, software, firmware, or combinations thereof. Other components, such as the communication element 12 and the memory element 14 may be utilized as well.

Various aspects related to the current invention are disclosed in “Phase Identification in Unobservable Distribution Systems”; Shweta Dahale, Anil Pahwa, Balasubramaniam Natarajan; IEEE Transactions on Power Delivery; Apr. 11, 2023; DOI: 10.1109/TPWRD.2023.3266302; which is hereby incorporated by reference into the current document.

The goal of some embodiments of the current invention is to determine the phase, i.e., the phase label A, B, or C, of (the voltage of) each of the laterals 106 and the customers 108 of the three phase power distribution network 100. The current invention is scalable and may determine the phase labels of the entirety of the three phase power distribution network 100 or any portion thereof. The phase labels of some of the laterals 106 and/or the customers 108 are already known. The determination of the unknown phase labels involves the generation of a new graph structure. The graph is defined as G=(V, E, A), wherein V, denotes a plurality of vertices of the graph G and V∈R^{M}, E is a plurality of edges of the graph G, and A is an M×M adjacency matrix, wherein M represents the set of phases at all of the buses, nodes, or vertices in the graph G.

The graph G is derived, at least in part, from the topology of the three phase power distribution network 100, wherein the vertices may include the feeders 104, the laterals 106, and the customers 108, and the edges may include the connections therebetween. Thus, the processing element 16 receives, through the communication element 12, a schematic list, a node list, a topology list, or similar documentation that identifies the electrical connections of all of the nodes of the three phase power distribution network 100. The electrical connection scheme of the three phase power distribution network 100 may be stored in an array, a database, or similar data structure in the memory element 14. If necessary or desired, the schematic list, the node list, the topology list, or similar documentation representing the three phase power distribution network 100 may be partitioned into sections, or portions, manually or automatically such that the embodiments of the current invention determine the phase labels of each section successively.

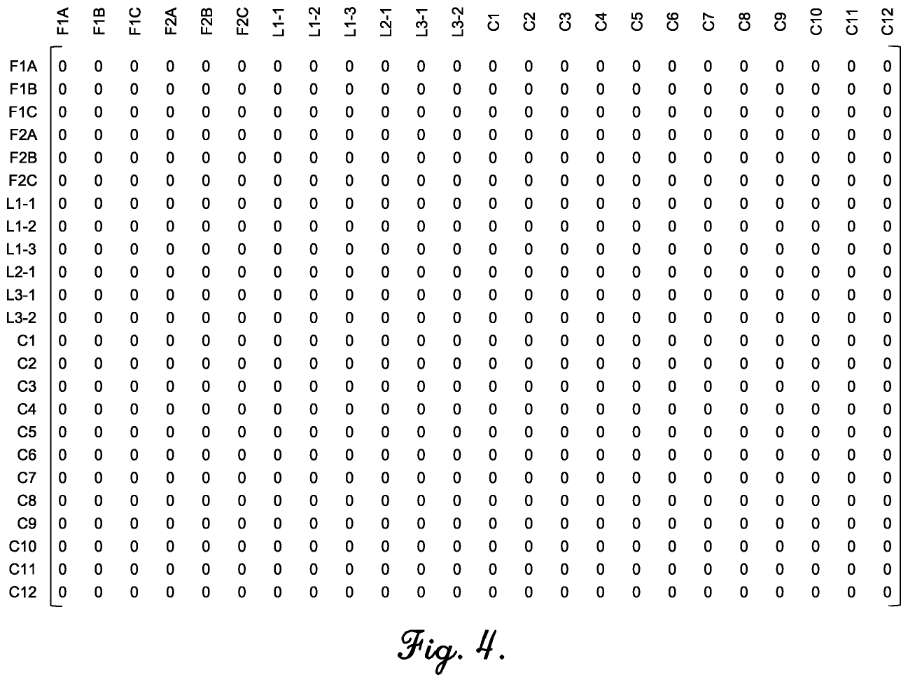

The adjacency matrix A is a square matrix whose entry values along its diagonal are 0 and whose entry values elsewhere are 0 or 1. The rows and the columns of the adjacency matrix A are derived from the vertices of the graph G, which are, in turn, derived from the feeders 104, the laterals 106, and the customers 108 and the connections therebetween of the three phase power distribution network 100. That is, for each feeder 104, each lateral 106, and each customer 108, the adjacency matrix A includes a row and a column. More specifically, for the phase connection of each feeder 104, each lateral 106, and each customer 108, the adjacency matrix A includes a row and a column. A blank (all entries have a 0 value) adjacency matrix A is shown in FIG. 4 with the heading of each row and column listed as well. The headings include a row heading and a column heading for the three phases of the first and second feeders 104, denoted as F1A, F1B, F1C, F2A, F2B, and F2C. The headings further include a row heading and a column heading for each phase of each lateral 106. In the exemplary three phase power distribution network 100, the first lateral 106 has three phases, and thus the headings are L1A, L1B, and L1C. The second lateral 106 has a single phase, which is unknown, and thus has the heading L2-1. The third lateral 106 has two unknown phases, and has the headings L3-1 and L3-2. The headings additionally include a row heading and a column heading for each customer 108, C1-C12.

When properly filled in, the adjacency matrix A includes a 1 for the value in the row and column entries that mark the intersection between two nodes (indicated by the row and column headings) which are connected on the three phase power distribution network 100. For example, it is known that phase A of the first feeder 104 is connected to phase A of the first lateral 106. Thus, a “1” is the value of the entries of the adjacency matrix A for (F1A, L1A) and (L1A, F1A). Furthermore, because the adjacency matrix A indicates the connection between pairs of nodes, it indicates the connections from the three phases of the feeders 104 through the various phases of the laterals 106 to the customers 108 and therefore can be used to determine the phase labels at each point in the three phase power distribution network 100. The contents of the adjacency matrix A may be determined by performing the following.

It is known that in a multi-phase power distribution grid, such as the three phase power distribution network 100, if two terminal buses of a feeder 104 or a lateral 106 are connected on the same phase, their phase voltage correlation is the largest. Higher voltage correlation is equivalent to smooth signals over the graph structure. This smoothness property can be quantified as:

$$l ( v ) = {\sum }_{( i , j )} A ( i , j ) {‖ {v}_{i} - {v}_{j} ‖}^{2} = tr ( {V}^{T} LV ) \qquad EQ . 1$$

where A is the adjacency matrix, A (i, j) denotes the connection between the nodes i and j, vᵢ-vⱼ denotes the distance between the nodes i and j. V is a matrix that includes voltage, or other electrical characteristic, measurements. L is a Laplacian matrix, which is defined as a degree matrix D (derived from the graph G) minus the adjacency matrix A. The “tr” term is a trace function which is defined to be a sum of the elements along the main diagonal of a matrix. The Laplacian quadratic form V^{T}LV measures the smoothness or voltage signal variance over the graph. Two nodes i and j are said to be connected if they have a small distance ||vᵢ-vⱼ|| or the term tr(V^{T}LV) is small. Accordingly, generating an adjacency matrix A that minimizes the term l(v) will determine the connections between the nodes so that the phase labels can be identified. The graph G is obtained by solving the general optimization problem:

$${min}_{A} tr ( {V}^{T} LV ) + η s ( A ) \qquad EQ . 2$$

wherein EQ. 2 is subject to constraints, η is a regularization parameter and η>0, and A is a symmetric matrix. After some substitution of terms and application of other mathematical principles, EQ. 2 becomes:

$${min}_{A , S} tr ( {V}^{T} LV ) + η {‖ A ‖}_{1} + β tr ( {S}^{T} LS ) + {λ}_{1} {‖ {P}_{Ω} ( A - {A}_{known} ) ‖}_{F}^{2} \qquad EQ . 3$$

subject to the following constraints:

$$0.5 \leq {\sum }_{m = 1}^{{p}_{j}} A ( {s}_{i} ( l ) , {t}_{j} ( m ) ) \leq 1 , ∀ i , ∀ j , i ∼ j \qquad EQ . 4$$

$$0.5 \leq {\sum }_{l = 1}^{{p}_{i}} A ( {s}_{i} ( l ) , {t}_{j} ( m ) ) \leq 1 , ∀ i , ∀ j , i ∼ j \qquad EQ . 5$$

$$A ( {s}_{i} ( l ) , {s}_{i} ( m ) ) \leq 0 \qquad EQ . 6$$

$$A ( {t}_{i} ( l ) , {t}_{i} ( m ) ) \leq 0 \qquad EQ . 7$$

wherein m, l=1, . . . , pᵢ, and i=1, . . . , K. In addition, S^{T}S=I (the identity matrix) and A∈ [symbol] .

EQ. 4 and EQ. 5 define must-link constraints. The must-link constraints specify that there should be only one connection among the phases between any two connected buses. The term i˜j implies that bus i is a neighbor of bus j. EQ. 6 and EQ. 7 define cannot-link constraints. The cannot-link constraints specify that the different phases in the same bus cannot be connected together i.e., the corresponding elements in the adjacency matrix should be set to zero.

Referring to EQ. 3, ||A || ₁ is a sparsity term. The term S is an estimated matrix, and the term β is a tuning value. The term A_{known} refers to phase labels of the nodes or buses of the three phase power distribution network 100 that are known, or suspected, in advance. Accordingly, the processing element 16 receives the node phase labels for a portion of the laterals 106, the customers 108, or both. The phase labels may be received in a list, wherein the list may include each lateral 106 or customer 108 for which the phase label is known along with the associated phase label. However, it is possible that some of the node phase labels are incorrect. The term λ₁ is a tuning value or weighting coefficient that adjusts a level of significance or impact that the A_{known} term has on EQ. 3. The value of λ₁ may be set according to a level of confidence regarding the previously known phase labels. If the previously known phase labels are believed to be accurate, then the value of λ₁ is set to be relatively high and the A_{known} term will be weighted more heavily. If there is less confidence that the previously known phase labels are accurate, then the value of λ₁ is set to be relatively low and the A_{known} term will be weighted less heavily.

To form the V matrix of EQ. 3, the processing element 16 receives a plurality of sensor data values from the sensors 110 on a periodic basis. Typically, the processing element 16 receives one or more sensor data values from each sensor 110 at a frequency of several times per day. For example, the processing element 16 may receive one or more sensor data values from each sensor 110 once every one or two hours. In some situations, the processing element 16 may receive a large quantity of sensor data values from each sensor 110 every one or two hours. Furthermore, it is possible that one or more of the sensors 110 transmits sensor data values less often.

The sensor data value includes a magnitude value of the voltage (voltage measurement) at each component and customer site. In various embodiments, the sensor data value may additionally, or alternatively, include a voltage angle, a real power value, a reactive power value, or the like, or combinations thereof. In addition, each sensor data value may be accompanied by an identifier that includes an identification code or number, a location, such as an address or geolocation, or both. Each sensor data value and its associated identifier may be stored in an array, a database, or similar data structure in the memory element 14.

The V matrix may have the form:

$$V = {[ {V}_{1}^{{p}_{1}} , … , {V}_{K}^{{p}_{K}} ]}^{T} ,$$

wherein

$${V}_{i}^{{p}_{i}}$$

includes the measured nodal voltages on bus i with phases pᵢ, e.g.,

$${V}_{i}^{{p}_{i}} = [ {V}_{i}^{a} , {V}_{i}^{b} , {V}_{i}^{c} ] .$$

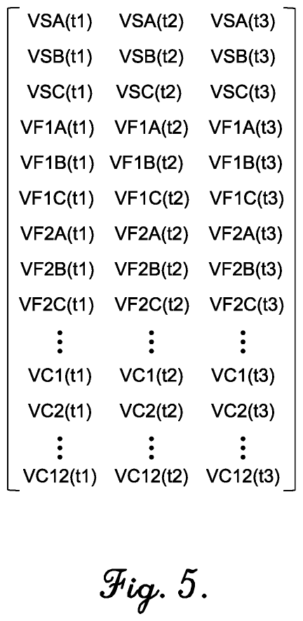

An example of the V matrix is shown in FIG. 5, wherein each row includes the voltage measurement (derived from the sensor data values) for a given phase, as necessary or appropriate, for a given node, and each column includes the voltage measurement during one of a plurality of time periods. That is, row 1, column 1 includes the voltage measurement for phase A of the substation 102 during a first time period—VSA(t1). Row 1, column 2 includes the voltage measurement for phase A of the substation 102 during a second time period—VSA(t2). Row 2, column 1 includes the voltage measurement for phase B of the substation 102 during a first time period—VSB(t1). Row 3, column 1 includes the voltage measurement for phase C of the substation 102 during a first time period—VSC(t1). Rows 4-6 include the voltage measurements for phases A, B, and C of the first feeder 104—VF1A, VF1B, and VF1C—for the given time periods. The subsequent rows follow the same pattern for the remaining feeders 104 and laterals 106. Afterward, the rows include the voltage measurements for each customer 108—VC1-VC12—for the given time periods, with one row per customer 108 since each customer 108, in this example, receives just one phase of voltage. If any customer 108 does not have the sensor 110 or the sensor 110 for any component or customer fails to transmit the sensor data value for a particular time period, then that entry is set to zero. The measurements from subsequent time periods are placed in the V matrix in columns to the right of the data already present.

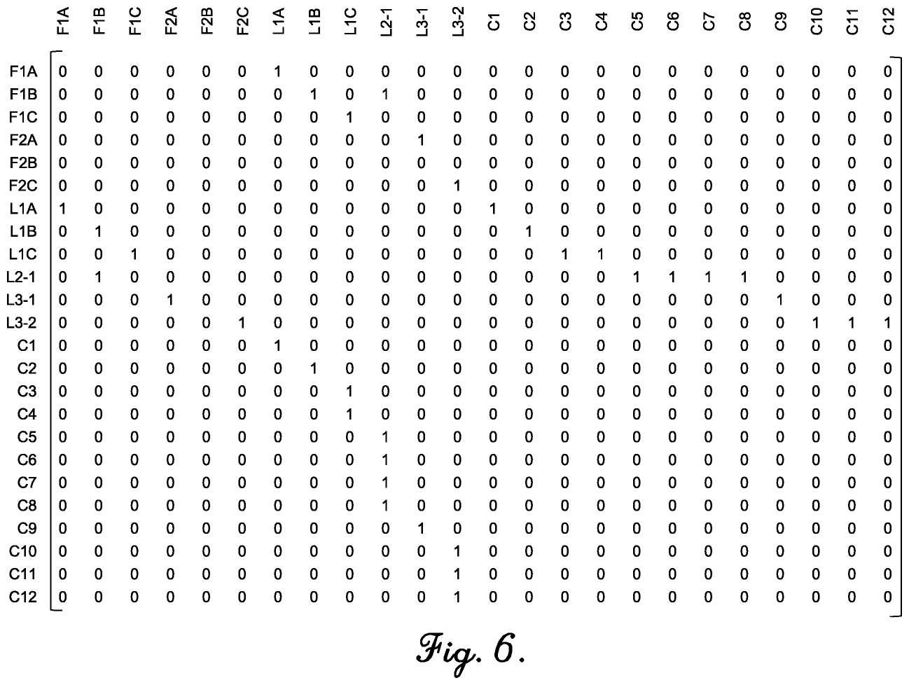

Once the processing element 16 receives the schematic list or node list that defines the topology of the three phase power distribution network 100, the processing element 16 generates the form of the adjacency matrix A and determines the must-link constraints and the cannot-link constraints. The processing element 16 also receives the known, or suspected, phase labels. The processing element 16 also determines the values for the coefficients η, β, and λ₁ to be used in EQ. 3. In some cases, the values for the coefficients may be manually set. In other cases, the values for the coefficients may be automatically set. The processing element 16 receives the sensor data values from all, or at least a portion, of the sensors 110 and generates the V matrix. Having received all of the necessary inputs, the processing element 16 solves EQ. 3 in order to determine the values for the adjacency matrix A that minimize the function of EQ. 3. The processing element 16 may utilize one or more algorithms, numerical or analytical processes, or software programs or applications, such as those available using MATLAB® from MathWorks in Natick, MA, to solve EQ. 3. An example of the determined adjacency matrix A for the three phase power distribution network 100 of FIG. 1 is shown in FIG. 6. The processing element 16 may determine the values for the adjacency matrix A every time a new set of sensor data values is received. However, it may not be necessary to redetermine the adjacency matrix A for each new set of sensor data values since the configuration or operation of the three phase power distribution network 100 may not have changed since the values for the adjacency matrix A were determined with the last set of inputs. Therefore, the values of the adjacency matrix A may be determined on a regular basis but over a longer period of time, or the values of the adjacency matrix A may be determined on an on-demand basis.

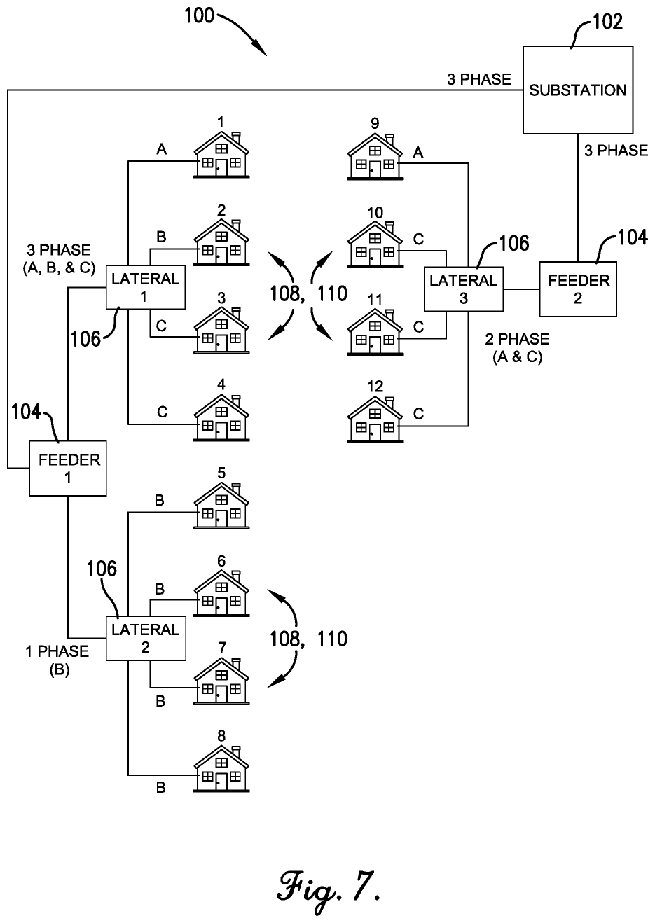

Once the values of the adjacency matrix A are determined, the phase labels of the voltages of the laterals 106 and the customers 108 are derived from the connections between the nodes indicated in the matrix. A “1” in one of the matrix entries indicates a connection between the nodes associated with the row and column of the entry. The phase labels of the laterals 106 are determined by searching the row associated with the lateral bus, determining the column in which the entry is a “1”, and then determining the feeder bus associated with the column. (The lateral phase label can also be determined by following the same steps but swapping the row and column.) For example, the only bus of lateral L2 has a “1” in the column associated with the feeder F1 phase B. Thus, the lateral L2 has a voltage of phase label B. The phase labels of the customers 108 are determined by searching the row associated with the customer, determining the column in which the entry is a “1”, and then determining the lateral bus associated with the column. (The customer phase label can also be determined by following the same steps but swapping the row and column.) For example, the row associated with customer C1 has a “1” in the entry for the column associated with lateral L1 phase A. Thus, the voltage at customer C1 has a phase label of A. An example of the phase labels derived from the adjacency matrix of FIG. 6 that are filled in on the three phase power distribution network 100 is shown in FIG. 7.

The hardware, software, and/or firmware embodiments of the current invention may be integrated with, or in communication with, hardware, software, and/or firmware of other computing devices or systems which monitor and manage the operation of electric power distribution networks such as the three phase power distribution network 100 illustrated in FIGS. 1 and 7. The embodiments of the current invention receive input data regarding the topology of the three phase power distribution network 100, any known phase labels, and the sensor data values. The embodiments of the current invention output the phase labels for each lateral 106 and customer 108. The phase labels are received by the other computing devices or systems which display (on a display screen or monitor) a model of the three phase power distribution network 100. The phase labels may be displayed as text adjacent to on-screen representations of each lateral 106 and customer 108. Additionally, or alternatively, the phase labels may be converted to a plurality of colors, wherein the phase label A is converted to a first color, the phase label B is converted to a second color, and the phase label C is converted to a third color. The colors may then be applied to on-screen representations of each lateral 106 and customer 108 to indicate the phase of the voltage at those points. Furthermore, the settings of various components that balance the load at the level of the customers 108 may vary according to the phase labels. For example, an electronic signal may be transmitted to one or more switches, or other components, to change their settings in order to adjust the load between two or more customers 108 if the phase label for the associated lateral 106 or the customers 108 changes.

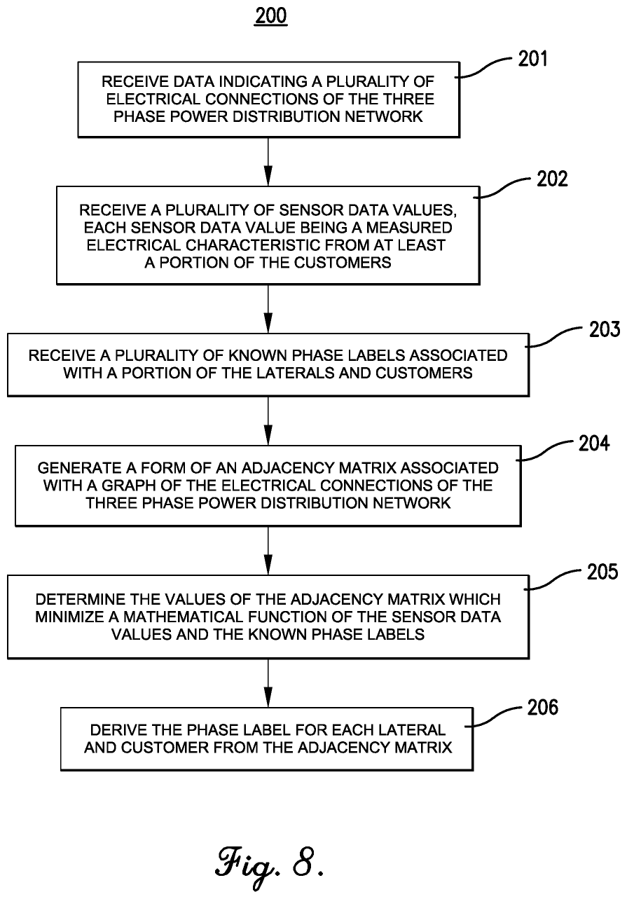

FIG. 8 depicts a listing of at least a portion of the steps of an exemplary computer-implemented method 200 for determining a plurality of phase labels, each phase label identifying a phase of a voltage at one of a lateral 106 or a customer 108 in a three phase power distribution network 100 formed by a plurality of nodes electrically connected to one another and including a plurality of laterals 106 and a plurality of customers 108. The steps may be performed in the order shown in FIG. 8, or they may be performed in a different order. Furthermore, some steps may be performed concurrently as opposed to sequentially. In addition, some steps may be optional or may not be performed. The steps may be performed by the processing element 16 of the computing device 10 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as the memory element 14.

Referring to step 201, data is received indicating a plurality of electrical connections of the three phase power distribution network 100. The data includes a schematic list, a node list, a topology list, or similar documentation that identifies the electrical connections of all of the nodes of the three phase power distribution network 100. The electrical connection scheme of the three phase power distribution network 100 may be stored in an array, a database, or similar data structure in the memory element 14. If necessary or desired, the schematic list, the node list, the topology list, or similar documentation representing the three phase power distribution network 100 may be partitioned into sections, or portions, manually or automatically such that the embodiments of the current invention determine the phase labels of each section successively.

Referring to step 202, a plurality of sensor data values is received. Typically, the processing element 16 receives one sensor data value from each sensor 110 at a frequency of several times per day. For example, the processing element 16 may receive one sensor data value from each sensor 110 once every one or two hours. Furthermore, it is possible that one or more of the sensors 110 transmits sensor data values less often.

The sensor data value includes a magnitude value of the voltage (voltage measurement) at the customer site. In various embodiments, the sensor data value may additionally, or alternatively, include a voltage angle, a real power value, a reactive power value, or the like, or combinations thereof. In addition, each sensor data value may be accompanied by an identifier that includes an identification code or number, a location, such as an address or geolocation, or both. Each sensor data value and its associated identifier may be stored in an array, a database, or similar data structure in the memory element 14.

Referring to step 203, a plurality of known phase labels associated with a portion of the laterals 106 and customers 108 is received. The phase labels may be received in a list, wherein the list may include each lateral 106 or customer 108 for which the phase label is known along with the associated phase label.

Referring to step 204, a form of an adjacency matrix A associated with a graph of the electrical connections of the three phase power distribution network 100 is generated. The adjacency matrix A is a square matrix whose entry values along its diagonal are 0 and whose entry values elsewhere are 0 or 1. The rows and the columns of the adjacency matrix A are derived from the vertices of the graph G, which are, in turn, derived from the feeders 104, the laterals 106, and the customers 108 and the connections therebetween of the three phase power distribution network 100. That is, for each feeder 104, each lateral 106, and each customer 108, the adjacency matrix A includes a row and a column. More specifically, for the phase connection of each feeder 104, each lateral 106, and each customer 108, the adjacency matrix A includes a row and a column. A blank (all entries have a 0 value) adjacency matrix A is shown in FIG. 4 with the heading of each row and column listed as well. The headings include a row heading and a column heading for the three phases of the first and second feeders 104, denoted as F1A, F1B, F1C, F2A, F2B, and F2C. The headings further include a row heading and a column heading for each phase of each lateral 106. In the exemplary three phase power distribution network 100, the first lateral 106 has three phases, and thus the headings are L1A, L1B, and L1C. The second lateral 106 has a single phase, which is unknown, and thus has the heading L2-1. The third lateral 106 has two unknown phases, and has the headings L3-1 and L3-2. The headings additionally include a row heading and a column heading for each customer 108, C1-C12.

When properly filled in, the adjacency matrix A includes a 1 for the value in the row and column entries that mark the intersection between two nodes (indicated by the row and column headings) which are connected on the three phase power distribution network 100. For example, it is known that phase A of the first feeder 104 is connected to phase A of the first lateral 106. Thus, a “1” is the value of the entries of the adjacency matrix A for (F1A, L1A) and (L1A, F1A). Furthermore, because the adjacency matrix A indicates the connection between pairs of nodes, it indicates the connections from the three phases of the feeders 104 through the various phases of the laterals 106 to the customers 108 and therefore can be used to determine the phase labels at each point in the three phase power distribution network 100.

Referring to step 205, the values of the adjacency matrix A which minimize a mathematical function of the sensor data values and the known phase labels are determined. The mathematical function is listed in EQ. 3 and is subject to the constraints of EQs. 4-7. EQ. 4 and EQ. 5 define must-link constraints. The must-link constraints specify that there should be only one connection among the phases between any two connected buses. The term i˜j implies that bus i is a neighbor of bus j. EQ. 6 and EQ. 7 define cannot-link constraints. The cannot-link constraints specify that the different phases in the same bus cannot be connected together i.e., the corresponding elements in the adjacency matrix should be set to zero.

Referring to EQ. 3, ||A|| ₁ is a sparsity term. The term S is an estimated matrix, and the term β is a tuning value. The term A_{known} refers to phase labels of the nodes or buses of the three phase power distribution network 100 that are known, or suspected, in advance. Accordingly, the processing element 16 receives the node phase labels for a portion of the laterals 106, the customers 108, or both. The phase labels may be received in a list, wherein the list may include each lateral 106 or customer 108 for which the phase label is known along with the associated phase label. However, it is possible that some of the node phase labels are incorrect. The term λ₁ is a tuning value or weighting coefficient that adjusts a level of significance or impact that the A_{known} term has on EQ. 3. The value of λ₁ may be set according to a level of confidence regarding the previously known phase labels. If the previously known phase labels are believed to be accurate, then the value of λ₁ is set to be relatively high and the A_{known} term will be weighted more heavily. If there is less confidence that the previously known phase labels are accurate, then the value of λ₁ is set to be relatively low and the A_{known} term will be weighted less heavily.

To form the V matrix of EQ. 3, the processing element 16 receives a plurality of sensor data values from the sensors 110 on a periodic basis. Typically, the processing element 16 receives one or more sensor data values from each sensor 110 at a frequency of several times per day. For example, the processing element 16 may receive one or more sensor data values from each sensor 110 once every one or two hours. In some situations, the processing element 16 may receive a large quantity of sensor data values from each sensor 110 every one or two hours. Furthermore, it is possible that one or more of the sensors 110 transmits sensor data values less often.

The sensor data value includes a magnitude value of the voltage (voltage measurement) at the customer site. In various embodiments, the sensor data value may additionally, or alternatively, include a voltage angle, a real power value, a reactive power value, or the like, or combinations thereof. In addition, in some embodiments, each sensor data value may be accompanied by an identifier that includes an identification code or number, a location, such as an address or geolocation, or both. Each sensor data value and its associated identifier may be stored in an array, a database, or similar data structure in the memory element 14.

The V matrix may have the form:

$$V = {[ {V}_{1}^{{p}_{1}} , … , {V}_{K}^{{p}_{K}} ]}^{T} ,$$

wherein

$${V}_{i}^{{p}_{i}}$$

includes the measured nodal voltages on bus i with phases pᵢ, e.g.,

$${V}_{i}^{{p}_{i}} = [ {V}_{i}^{a} , {V}_{i}^{b} , {V}_{i}^{c} ] .$$

An example of the V matrix is shown in FIG. 5, wherein each row includes the voltage measurement (derived from the sensor data values) for a given phase, as necessary or appropriate, for a given node, and each column includes the voltage measurement during one of a plurality of time periods. That is, row 1, column 1 includes the voltage measurement for phase A of the substation 102 during a first time period—VSA(t1). Row 1, column 2 includes the voltage measurement for phase A of the substation 102 during a second time period—VSA(t2). Row 2, column 1 includes the voltage measurement for phase B of the substation 102 during a first time period—VSB(t1). Row 3, column 1 includes the voltage measurement for phase C of the substation 102 during a first time period—VSC(t1). Rows 4-6 include the voltage measurements for phases A, B, and C of the first feeder 104—VF1A, VF1B, and VF1C—for the given time periods. The subsequent rows follow the same pattern for the remaining feeders 104 and laterals 106. Afterward, the rows include the voltage measurements for each customer 108—VC1-VC12—for the given time periods, with one row per customer 108 since each customer 108, in this example, receives just one phase of voltage. If any customer 108 does not have the sensor 110 or the sensor 110 for any component or customer fails to transmit the sensor data value for a particular time period, then that entry is set to zero. The measurements from subsequent time periods are placed in the V matrix in columns to the right of the data already present.

Once the processing element 16 receives the schematic list or node list that defines the topology of the three phase power distribution network 100, the processing element 16 generates the form of the adjacency matrix A and determines the must-link constraints and the cannot-link constraints. The processing element 16 also receives the known, or suspected, phase labels. The processing element 16 also determines the values for the coefficients η, β, and λ₁ to be used in EQ. 3. In some cases, the values for the coefficients may be manually set. In other cases, the values for the coefficients may be automatically set. The processing element 16 receives the sensor data values from all, or at least a portion, of the sensors 110 and generates the V matrix. Having received all of the necessary inputs, the processing element 16 solves EQ. 3 in order to determine the values for the adjacency matrix A that minimize the function of EQ. 3. The processing element 16 may utilize one or more algorithms, numerical or analytical processes, or software programs or applications, such as those available using MATLAB® from MathWorks in Natick, MA, to solve EQ. 3. An example of the determined adjacency matrix A for the three phase power distribution network 100 of FIG. 1 is shown in FIG. 6. The processing element 16 may determine the values for the adjacency matrix A every time a new set of sensor data values is received. However, it may not be necessary to redetermine the adjacency matrix A for each new set of sensor data values since the configuration or operation of the three phase power distribution network 100 may not have changed since the values for the adjacency matrix A were determined with the last set of inputs. Therefore, the values of the adjacency matrix A may be determined on a regular basis but over a longer period of time, or the values of the adjacency matrix A may be determined on an on-demand basis.

Referring to step 206, the phase label for each lateral 106 and customer 108 from the adjacency matrix A is derived. Once the values of the adjacency matrix A are determined, the phase labels of the voltages of the laterals 106 and the customers 108 are derived from the connections between the nodes indicated in the matrix. A “1” in one of the matrix entries indicates a connection between the nodes associated with the row and column of the entry. The phase labels of the laterals 106 are determined by searching the row associated with the lateral bus, determining the column in which the entry is a “1”, and then determining the feeder bus associated with the column. (The lateral phase label can also be determined by following the same steps but swapping the row and column.) For example, the only bus of lateral L2 has a “1” in the column associated with the feeder F1 phase B. Thus, the lateral L2 has a voltage of phase label B. The phase labels of the customers 108 are determined by searching the row associated with the customer, determining the column in which the entry is a “1”, and then determining the lateral bus associated with the column. (The customer phase label can also be determined by following the same steps but swapping the row and column.) For example, the row associated with customer C1 has a “1” in the entry for the column associated with lateral L1 phase A. Thus, the voltage at customer C1 has a phase label of A. An example of the phase labels derived from the adjacency matrix of FIG. 6 that are filled in on the three phase power distribution network 100 is shown in FIG. 7.

Embodiments of the current invention provide robust operation and can determine phase labels of the voltages for the three phase power distribution network 100 accurately even when sensor data values are missing from some of the customers 108 and even when the previously known phase labels are incorrect.

Another embodiment of the current invention provides a method 300 for estimating a state of a three phase power distribution network 100. The method 300 may be utilized with, or as a component of, distributed energy resource management systems (DERMS), a software system that manages all distributed energy resources, wherein the distributed energy resources include photovoltaics (solar panels), electric vehicles, energy storage devices (residential or commercial battery systems), and the like. The state of the three phase power distribution network 100 includes the following state variables: the active power injection or consumption, the reactive power injection or consumption, the voltage magnitude, and the voltage phase angle (sometimes presented as real and imaginary components) at each node of the three phase power distribution network 100. If every sensor 110 in the three phase power distribution network 100 transmitted the measured values of all of the state variables at each time period, then the state of the three phase power distribution network 100 would be known. However, some nodes may not have the sensor 110, the sensor 110 may be malfunctioning, the sensor 110 may not transmit at every time period, the sensor 110 may transmit only a portion of the state variables, and so forth, which lead to an incomplete state of the three phase power distribution network 100. Thus, the state of the three phase power distribution network 100 needs to be estimated using the method 300.

Generally, to accurately estimate the state of the three phase power distribution network 100, an accurate (as possible) model of the three phase power distribution network 100 is required. The model includes the schematic connection between the nodes of the three phase power distribution network 100. Typically, the connection between any two nodes of the three phase power distribution network 100 is known. For example, with reference to FIGS. 1 and 7, it is known that customer C1 is connected to lateral L1, which is connected to feeder F1. But, knowing the phase (as indicated by the phase label A, B, or C) from the method 200 completes the model of the three phase power distribution network 100.

The state of the three phase power distribution network 100 may be expressed as a tensor [symbol] ∈ [symbol] ^{M×5×N}, which is constructed by creating an array of state measurement matrices of the three phase power distribution network 100, where M is a plurality of measurements (measured voltage and/or power values), one measurement at each node of the three phase power distribution network 100, and N is a number of the measurements, one measurement per time period. The matrix obtained at a single time instant, t, has a structure of T∈ [symbol] ^{M×5} and is expressed as shown in EQ. 8:

$$T = [ {P}_{t} , {Q}_{t} , ℜ ( {v}_{t} ) , 𝔍 ( {v}_{t} ) , \vert {v}_{t} \vert ] \qquad EQ . 8$$

where, for the columns, Pₜ is the active power injection and Qₜ is the reactive power injection at a time t. The term [symbol] (vₜ) is the real part of the voltage phase angle, the term J(vₜ) is the imaginary part of the voltage phase angle, and |vₜ| is the magnitude of the voltage at a time t for each phase of the non-slack buses. Each row of the matrix T includes the measured values for a single node of the three phase power distribution network 100.

For reasons discussed above, some of the measured values of the state variables that would be entered into the components of T in EQ. 8 are missing. Tensor completion fills the missing elements in the measurement tensor T by utilizing the sparsity in data with linearized power flow constraints at every time instant. The linearized power flow constraints require knowledge of a stored admittance matrix

$$( {Y}_{LL}^{s} ) ,$$

which includes electrical admittance values between connected nodes of non-slack buses of the three phase power distribution network 100. A utility company or other manager of the three phase power distribution network 100 has the knowledge of the admittance matrix, which may be stored in a distribution management database. However, the stored admittance matrix is often outdated or incomplete and needs to be updated to an estimated admittance matrix

$$( {Y}_{LL}^{( i , j )} ∈ {ℝ}^{3 \times 3} )$$

as determined by EQ. 9:

$${Y}_{LL}^{( i , j )} = {Y}_{LL}^{s ( i , j )} π \qquad EQ . 9$$

where π is a permutation matrix which includes values of 0 and 1 only and is generally equivalent to the adjacency matrix A determined in the method 200. The terms i and j refer to buses of the three phase power distribution network 100 labeled i and j. To continue with tensor completion, the estimated (updated) admittance matrix serves as input to calculate D and K, which represent modified linearized components of the estimated admittance matrix and are obtained from the linearization of bus voltage phasors (angles) and magnitudes. D and K are defined as shown in EQ. 10 and EQ. 11, respectively:

$$D = ( {Y}_{LL}^{- 1} diag {( \overline{w} )}^{- 1} , - {jY}_{LL}^{- 1} diag {( \overline{w} )}^{- 1} ) \qquad EQ . 10$$

$$K = ( {\vert diag ( \overline{w} ) \vert}^{- 1} ℜ \{ diag ( \overline{w} ) D \} ) \qquad EQ . 11$$

where

$$w = - {Y}_{LL}^{- 1}$$

is the zero-load voltage.

With D and K calculated, tensor completion continues by solving the optimization equation given in EQ. 12:

$$\hat{𝒳} = {min}_{x} {\sum }_{i = 1}^{3} \frac{{β}_{i}}{2} {‖ {ℳ}_{i} - {𝒳}_{( i )} ‖}_{F}^{2} + {1}_{} γ + {2}_{} α \qquad EQ . 12$$

with the linearized power flow constraints such that ||vₜ−Dxₜ−w ||_{∞}≤γ; and |||vₜ|−Kxₜ−|w|||_{∞}≤α; and t∈1,2, . . . , N; where vₜ is the bus voltage phase angle vector at time t, xₜ is the vector of active and reactive power injections of all buses at time t, and the subscript i denotes the unfolding operation applied to the tensor T along the node i. Mᵢ is one of the three unfoldings of the measurement tensor, wherein the unfoldings include active power, reactive power, and voltage. The constraints are included to satisfy the linear approximations of the voltage phasor and voltage magnitude. α (alpha) and γ (gamma) represent the dummy variables introduced to relax these constraints. β (beta) represents weighting components and is a constant term in EQ. 12. w₁ and w₂ are the weights associated with the dummy variables γ and α, respectively. The tensor completion involves determining values of the active power and reactive power that will minimize EQ. 12. The tensor completion, including the steps of: determining the adjacency matrix, determining the estimated admittance matrix, linearizing the estimated admittance matrix, and determining the values of the active power and reactive power that will minimize EQ. 12, may be performed iteratively to complete the matrix of EQ. 8, which estimates the state of the three phase power distribution network 100. The tensor completion may be repeated a fixed number of times or until a convergence factor is met.

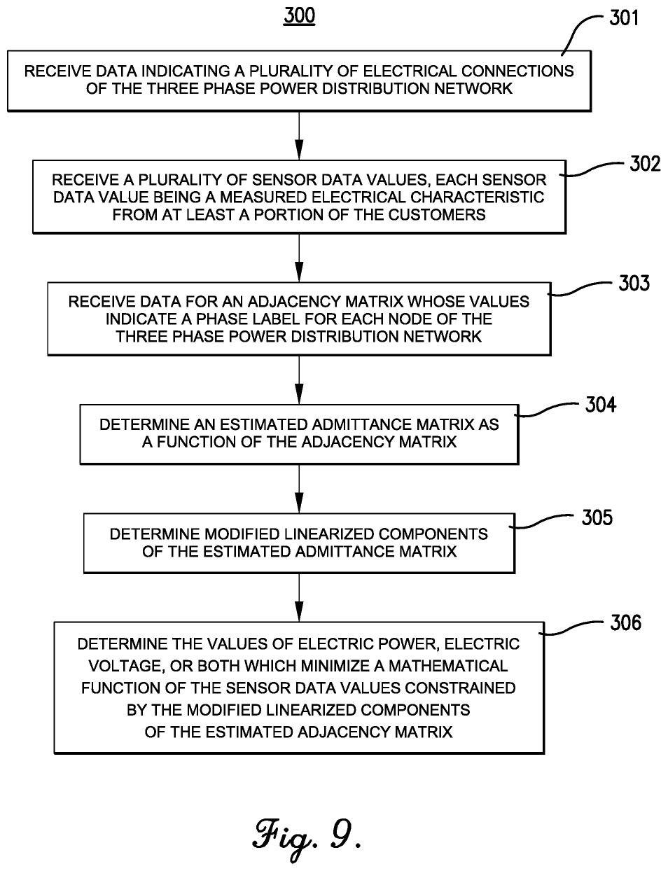

FIG. 9 depicts a listing of at least a portion of the steps of an exemplary computer-implemented method 300 for estimating a state of the three phase power distribution network 100 formed by a plurality of nodes electrically connected to one another and including a plurality of laterals 106 and a plurality of customers 108. The steps may be performed in the order shown in FIG. 9, or they may be performed in a different order. Furthermore, some steps may be performed concurrently as opposed to sequentially. In addition, some steps may be optional or may not be performed. The steps may be performed by the processing element 16 of the computing device 10 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as the memory element 14.

Referring to step 301, data is received indicating a plurality of electrical connections of the three phase power distribution network 100. The data includes a schematic list, a node list, a topology list, or similar documentation that identifies the electrical connections of all of the nodes of the three phase power distribution network 100. The electrical connection scheme of the three phase power distribution network 100 may be stored in an array, a database, or similar data structure in the memory element 14. If necessary or desired, the schematic list, the node list, the topology list, or similar documentation representing the three phase power distribution network 100 may be partitioned into sections, or portions, manually or automatically such that the embodiments of the current invention determine the phase labels of each section successively.

Referring to step 302, a plurality of sensor data values is received. Typically, the processing element 16 receives one sensor data value from each sensor 110 at a frequency of several times per day. For example, the processing element 16 may receive one sensor data value from each sensor 110 once every one or two hours. Furthermore, it is possible that one or more of the sensors 110 transmits sensor data values less often.

The sensor data value includes a magnitude value of the voltage (voltage measurement) at the customer site. In various embodiments, the sensor data value may additionally, or alternatively, include a voltage angle, a real or active power value, a reactive power value, or the like, or combinations thereof. In addition, each sensor data value may be accompanied by an identifier that includes an identification code or number, a location, such as an address or geolocation, or both. Each sensor data value and its associated identifier may be stored in an array, a database, or similar data structure in the memory element 14.

Referring to step 303, data is received for an adjacency matrix A whose values indicate a phase label for each node of the three phase power distribution network 100. The adjacency matrix A is a square matrix whose entry values along its diagonal are 0 and whose entry values elsewhere are 0 or 1. The rows and the columns of the adjacency matrix A are derived from the vertices of the graph G, which are, in turn, derived from the feeders 104, the laterals 106, and the customers 108 and the connections therebetween of the three phase power distribution network 100. That is, for each feeder 104, each lateral 106, and each customer 108, the adjacency matrix A includes a row and a column. More specifically, for the phase connection of each feeder 104, each lateral 106, and each customer 108, the adjacency matrix A includes a row and a column. A blank (all entries have a 0 value) adjacency matrix A is shown in FIG. 4 with the heading of each row and column listed as well. The headings include a row heading and a column heading for the three phases of the first and second feeders 104, denoted as F1A, F1B, F1C, F2A, F2B, and F2C. The headings further include a row heading and a column heading for each phase of each lateral 106. In the exemplary three phase power distribution network 100, the first lateral 106 has three phases, and thus the headings are L1A, L1B, and L1C. The second lateral 106 has a single phase, which is unknown, and thus has the heading L2-1. The third lateral 106 has two unknown phases, and has the headings L3-1 and L3-2. The headings additionally include a row heading and a column heading for each customer 108, C1-C12.

When properly filled in, the adjacency matrix A includes a 1 for the value in the row and column entries that mark the intersection between two nodes (indicated by the row and column headings) which are connected on the three phase power distribution network 100. For example, it is known that phase A of the first feeder 104 is connected to phase A of the first lateral 106. Thus, a “1” is the value of the entries of the adjacency matrix A for (F1A, L1A) and (L1A, F1A). Furthermore, because the adjacency matrix A indicates the connection between pairs of nodes, it indicates the connections from the three phases of the feeders 104 through the various phases of the laterals 106 to the customers 108 and therefore can be used to determine the phase labels at each point in the three phase power distribution network 100. The contents of the adjacency matrix A may be determined by performing the steps of method 200.

Referring to step 304, an estimated admittance matrix is determined as a function of the adjacency matrix A. The estimated admittance matrix is also determined as a function of a stored admittance matrix

$$( {Y}_{LL}^{s} ) ,$$

which includes electrical admittance values between connected nodes of non-slack buses of the three phase power distribution network 100. A utility company or other manager of the three phase power distribution network 100 has the knowledge of the admittance matrix, which may be stored in a distribution management database. The stored admittance matrix is updated to an estimated admittance matrix

$$( {Y}_{LL}^{( i , j )} ∈ {ℝ}^{3 \times 3} )$$

as determined by EQ. 9 above, where π is a permutation matrix which includes values of 0 and 1 only and is generally equivalent to the adjacency matrix A determined in the method 200.

Referring to step 305, modified linearized components of the estimated admittance matrix are determined. Elements D and K represent modified linearized components of the estimated admittance matrix and are obtained from the linearization of bus voltage phasors (angles) and magnitudes. D and K are determined by solving the equations shown in EQ. 10 and EQ. 11, respectively.

Referring to step 306, the values of electric power, electric voltage, or both are determined, which minimize a mathematical function of the sensor data values constrained by the modified linearized components of the estimated adjacency matrix. The mathematical equation is shown in EQ. 12 above and the constraints are presented thereafter.

In various embodiments, steps 303-306 may be repeated or performed iteratively to complete the matrix of EQ. 8, which estimates the state of the three phase power distribution network 100. Steps 303-306 may be repeated a fixed number of times or until a convergence factor is met.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A computer-implemented method for determining a plurality of phase labels, each phase label identifying a phase of a voltage at one of a lateral or a customer in a three phase power distribution network formed by a plurality of nodes electrically connected to one another and including a plurality of laterals and a plurality of customers, the method comprising:
receiving data indicating a plurality of electrical connections of the three phase power distribution network;
receiving a plurality of sensor data values, each sensor data value being a measured electrical characteristic from at least a portion of the customers;
receiving a plurality of known phase labels associated with a portion of the laterals and customers;
generating a form of an adjacency matrix associated with a graph of the electrical connections of the three phase power distribution network;
determining the values of the adjacency matrix which minimize a mathematical function of the sensor data values and the known phase labels; and
deriving the phase label for each lateral and customer from the adjacency matrix.

2. The computer-implemented method of claim 1, wherein the values of the adjacency matrix indicate whether or not any two nodes of the three phase power distribution network are connected to one another.

3. The computer-implemented method of claim 2, wherein the phase labels are derived from the adjacency matrix according to a connection between nodes of the three phase power distribution network.

4. The computer-implemented method of claim 1, further comprising determining:
a plurality of must-link constraints of the electrical connections of the three phase power distribution network, each must-link constraint specifying only one connection among the phases between a first bus connected to a second bus, and
a plurality of cannot-link constraints of the electrical connections of the three phase power distribution network, each cannot-link constraint specifying different phases on a bus cannot be connected together.

5. The computer-implemented method of claim 1, further comprising forming a matrix from the sensor data values, wherein the entries for each row of the matrix include the sensor data value for a given phase, if necessary, for a given node, and the entries for each column include the sensor data value during one of a plurality of time periods.

6. The computer-implemented method of claim 1, wherein the mathematical function includes a tuning coefficient that is multiplied by a term including the known phase labels, a value of the tuning coefficient varying according to a confidence level of an accuracy of the known phase labels.

7. The computer-implemented method of claim 1, further comprising displaying an indication of the phase label for each lateral and customer on a display.

8. A computing device for determining a plurality of phase labels, each phase label identifying a phase of a voltage at one of a lateral or a customer in a three phase power distribution network formed by a plurality of nodes electrically connected to one another and including a plurality of laterals and a plurality of customers, the computing device comprising:
a processing element in electronic communication with a memory element, the processing element configured or programmed to:
receive data indicating a plurality of electrical connections of the three phase power distribution network;
receive a plurality of sensor data values, each sensor data value being a measured electrical characteristic from at least a portion of the customers;
receive a plurality of known phase labels associated with a portion of the laterals and customers;
generate a form of an adjacency matrix associated with a graph of the electrical connections of the three phase power distribution network;
determine the values of the adjacency matrix which minimize a mathematical function of the sensor data values and the known phase labels; and
derive the phase label for each lateral and customer from the adjacency matrix.

9. The computing device of claim 8, wherein the values of the adjacency matrix indicate whether or not any two nodes of the three phase power distribution network are connected to one another.

10. The computing device of claim 9, wherein the phase labels are derived from the adjacency matrix according to a connection between nodes of the three phase power distribution network.

11. The computing device of claim 8, wherein the processing element is further configured to determine:
a plurality of must-link constraints of the electrical connections of the three phase power distribution network, each must-link constraint specifying only one connection among the phases between a first bus connected to a second bus, and
a plurality of cannot-link constraints of the electrical connections of the three phase power distribution network, each cannot-link constraint specifying different phases on a bus cannot be connected together.

12. The computing device of claim 8, wherein the processing element is further configured to form a matrix from the sensor data values, wherein the entries for each row of the matrix include the sensor data value for a given phase, if necessary, for a given node, and the entries for each column include the sensor data value during one of a plurality of time periods.

13. The computing device of claim 8, wherein the mathematical function includes a tuning coefficient that is multiplied by a term including the known phase labels, a value of the tuning coefficient varying according to a confidence level of an accuracy of the known phase labels.

14. The computing device of claim 8, wherein the processing element is further configured to display an indication of the phase label for each lateral and customer on a display.

15. A non-transitory computer readable medium having stored thereon software instructions for determining a plurality of phase labels, each phase label identifying a phase of a voltage at one of a lateral or a customer in a three phase power distribution network formed by a plurality of nodes electrically connected to one another and including a plurality of laterals and a plurality of customers that, when executed by a processing element, cause the processing element to:
receive data indicating a plurality of electrical connections of the three phase power distribution network;
receive a plurality of sensor data values, each sensor data value being a measured electrical characteristic from at least a portion of the customers;
receive a plurality of known phase labels associated with a portion of the laterals and customers;
generate a form of an adjacency matrix associated with a graph of the electrical connections of the three phase power distribution network;
determine the values of the adjacency matrix which minimize a mathematical function of the sensor data values and the known phase labels; and
derive the phase label for each lateral and customer from the adjacency matrix.

16. The non-transitory computer readable medium of claim 15, wherein the values of the adjacency matrix indicate whether or not any two nodes of the three phase power distribution network are connected to one another and the phase labels are derived from the adjacency matrix according to a connection between nodes of the three phase power distribution network.

17. The non-transitory computer readable medium of claim 15, wherein the processing element is further caused to determine:
a plurality of must-link constraints of the electrical connections of the three phase power distribution network, each must-link constraint specifying only one connection among the phases between a first bus connected to a second bus, and
a plurality of cannot-link constraints of the electrical connections of the three phase power distribution network, each cannot-link constraint specifying different phases on a bus cannot be connected together.

18. The non-transitory computer readable medium of claim 15, wherein the processing element is further caused to form a matrix from the sensor data values, wherein the entries for each row of the matrix include the sensor data value for a given phase, if necessary, for a given node, and the entries for each column include the sensor data value during one of a plurality of time periods.

19. The non-transitory computer readable medium of claim 15, wherein the mathematical function includes a tuning coefficient that is multiplied by a term including the known phase labels, a value of the tuning coefficient varying according to a confidence level of an accuracy of the known phase labels.

20. The non-transitory computer readable medium of claim 15, wherein the processing element is further caused to display an indication of the phase label for each lateral and customer on a display.

21. A computer-implemented method for estimating a state of a three phase power distribution network formed by a plurality of nodes electrically connected to one another and including a plurality of laterals and a plurality of customers, the method comprising:
receiving data indicating a plurality of electrical connections of the three phase power distribution network;
receiving a plurality of sensor data values, each sensor data value being a measured electrical characteristic from at least a portion of the customers;
receiving data for an adjacency matrix whose values indicate a phase label for each node of the three phase power distribution network;
determining an estimated admittance matrix as a function of the adjacency matrix;
determining modified linearized components of the estimated admittance matrix; and
determining the values of electric power, electric voltage, or both which minimize a mathematical function of the sensor data values constrained by the modified linearized components of the estimated adjacency matrix.

22. The computer-implemented method of claim 21, wherein the last four steps of the method are repeated a fixed number of times.

23. The computer-implemented method of claim 21, wherein the data for the adjacency matrix is determined by:
receiving a plurality of known phase labels associated with a portion of the laterals and customers;
generating a form of an adjacency matrix associated with a graph of the electrical connections of the three phase power distribution network; and
determining the values of the adjacency matrix which minimize a mathematical function of the sensor data values and the known phase labels.

24. The computer-implemented method of claim 21, wherein the estimated admittance matrix is calculated as a product of a stored admittance matrix and the adjacency matrix.

25. The computer-implemented method of claim 21, wherein the mathematical function further includes variables to relax the constraint of the modified linearized components.
